(19) United States
(12) Patent Application Publication
(10) Pub. No.: US 2017/0321481 A1
(43) Pub. Date: Nov. 9, 2017

(54) LIGHT ADJUSTMENT SYSTEM FOR A WINDOW

(71) Applicant: Sina Ashkanmehr, Dezful (IR)

(72) Inventor: Sina Ashkanmehr, Dezful (IR)

(21) Appl. No.: 15/658,344

(22) Filed: Jul. 24, 2017

Related U.S. Application Data
(63) Continuation-in-part of application No. PCT/IB2015/059024, filed on Nov. 21, 2015.

(30) Foreign Application Priority Data
Feb. 12, 2015 (IR) 13935014000301271

(51) Int. Cl. E06B 9/70; E06B 9/42; E06B 9/40; E06B 9/24; E06B 9/68

(52) U.S. Cl. CPC E06B 9/70; E06B 9/42; E06B 2009/6809; E06B 2009/2405; E06B 2009/6827; E06B 2009/405

(57) ABSTRACT

A method and system for changing light intensity that passes through a window is disclosed. The method includes securing a sheet with a plurality of portions to a window, wherein each portion has a respective transparency, and arranging the sheet in a first position such that a first portion of the sheet with a first transparency is placed in front of the window. In addition, the system is configured to allow the sheet to move from the first position to a second position, such that a second portion of the sheet with a second transparency is placed in front of the window.

### CROSS-REFERENCE TO RELATED APPLICATIONS

This application claims the benefit of priority from pending International Application Number PCT/IB2015/059024, filed on Nov. 21, 2015, published as WO 2016/128809 on Aug. 18 2016, and entitled “INTELLIGENT WINDOW WITH THE ABILITY TO CONTROL LIGHT EITHER INTELLIGENTLY OR MANUALLY,” which claims priority to Iranian Patent Application 139350140003012712, filed on Feb. 12, 2015, both of which are incorporated herein by reference in their entirety.

### TECHNICAL FIELD

The present disclosure generally relates to systems for adjusting the amount of light traveling through a pane of a window, and particularly to an intelligent system for adjusting the amount of light traveling through a window pane.

### BACKGROUND

Controlling or adjusting the amount of light passing through a glass window, partition, or door in turn adjusts the amount of light and energy that enters or exits a room or an office. For example, during summer months, a large amount of sunlight may enter the room from the windows, which heats up the room and makes it necessary to consume a considerable amount of energy to cool the room. Therefore, reducing the amount of light passing through the windows may save energy that would otherwise be consumed by cooling systems. On the other hand, during winter months, sunlight passing through windows may be utilized to heat the room and reduce the amount of energy that would otherwise be consumed by heating systems. Furthermore, controlling or adjusting the amount of light passing through a glass window, partition, or door facilitates adjustments to the privacy of a room or office.

Different technologies have been used for controlling and managing the amount of light travelling through windows. For example, electro-chromic glasses, nano liquid crystal glasses, poly crystal glasses, light sensitive glasses (photo chromic), or nano-crystal glasses have been used in windows, glass partitions, or doors. However, high manufacturing costs of the abovementioned technologies may make their mass production difficult.

There is a need in the art for simple systems and technologies for adjusting the amount of light traveling through a window pane that permits manual or automatic control of the light intensity passing through the window. There is further a need in the art for simple-to-use intelligent windows capable of adjusting the amount of light traveling therethrough, based on the temperature and the light intensity of the room.

### SUMMARY

This summary is intended to provide an overview of the subject matter of this patent, and is not intended to identify essential elements or key elements of the subject matter, nor is it intended to be used to detennine the scope of the claimed implementations. The proper scope of this patent may be ascertained from the claims set forth below in view of the detailed description below and the drawings.

In one general aspect, the present disclosure describes a method for adjusting the light intensity of light passing through a window pane of a window. The method includes securing a sheet to the window, where the sheet includes plurality of portions, and the plurality of portions include at least a first portion with a first transparency and a second portion with a second transparency, the first transparency differing from the second transparency. The method further includes positioning the sheet in a first position alongside the window pane such that the first portion extends directly alongside the window pane, and transitioning the sheet from the first position to a second position such that the second portion of the sheet extends alongside the window pane.

The above general aspect may include one or more of the following features. For example, in some cases a third portion with a third transparency is disposed between the first portion and the second portion in a lengthwise direction, where the first transparency is greater than the second transparency, and where the third transparency is less than the first transparency and greater than the second transparency. In one implementation, the transparencies of each of the first portion, second portion, and third portion change discretely from one portion to the next. In another example, the third portion includes a gradient tint, such that the transparency of the third portion varies gradually across the length of the third portion. Furthermore, the window pane can have a surface area, and each portion of the sheet may be sized to cover at least the surface area of the window pane. In addition, securing the sheet to the window may include mounting the sheet to a surface adjacent to the window. In some cases, securing the sheet to the window includes securing a first motor and a first roller to a surface adjacent to the window. In another example, transitioning the sheet from the first position to the second position can also include winding the first portion of the sheet onto the first roller by activation of the first motor. The method may also include selecting a desired light intensity on a controller associated with, the sheet. In one case, transitioning the sheet from the first position to the second position also includes unwinding the second portion from a second roller.

In different implementations, it can be understood that a method may include providing a sheet with a plurality of portions, wherein each portion has a respective transparency, associating the sheet with the window in a first position, such that a first portion of the sheet with a first transparency is placed in front of the window, and moving the sheet from the first position to a second position, such that a second portion of the sheet with a second transparency is placed in front of the window. In another implementation, the respective transparency of each portion may discretely change from a portion to the next. In another implementation, the respective transparency of each portion may continuously change from one portion to an adjacent portion, forming a gradient tint on the sheet. According to another implementation, each portion of the sheet may be sized to cover the surface area of the window. In some cases, associating the sheet with the window may include attaching the sheet to a surface near the window.

In another general aspect, the present disclosure describes a system for adjusting light intensity passing through a window pane of a window. The system includes a sheet with a plurality of portions, the plurality of portions including at least a first portion with a first transparency and a second portion with a second transparency that differs from the first transparency. The system also includes an actuating mechanism coupled to the sheet, where the actuating mechanism is configured to move the sheet between a first position in which the first portion extends alongside the window pane to a second position in which the second portion extends alongside the window pane.

The above general, aspect may include one or more of the following features. In some cases, the actuating mechanism includes a roller coupled with a rotary actuator, and the rotary actuator drives rotational movements of the roller to roll or unroll the sheet around the roller, thereby moving different portions of the sheet in front of the window. In another implementation, the system further includes a controller configured to transmit commands to the actuating mechanism, thereby adjusting a relative position of each of the portions of the sheet. In one example, the system also includes a sensor system, where the sensor system is configured to measure the light intensity of light that passes through the window pane, and the sensor system is coupled to the controller. In other cases, the system can include a user interface unit configured to receive input from a user regarding a selection of a predefined amount of light intensity permitted to pass through the window. In some implementations, the plurality of portions further includes a third portion disposed between the first portion and the second portion, where the third portion has a third transparency, and the value of the third transparency is between the value of the first transparency and the value of the second transparency. In another example, the value of the third transparency is substantially constant along the entirety of the material comprising the third portion. Alternatively, the third portion can include a gradient tint, whereby the value of the third transparency varies (i.e., increases or decreases) gradually along a length or width of the third portion.

In another general aspect, the present disclosure describes a window system capable of adjusting light intensity of light passing through a window. The window system includes a frame surrounding a first window pane, where the material of the first window pane includes glass, and a sheet that extends between a first roller and a second roller. The sheet includes a plurality of portions, and each portion has a respective or distinct transparency level. Furthermore, the window system includes an actuating mechanism coupled to the sheet. The actuating mechanism is configured to move and position different portions of the sheet alongside the first window pane.

The above general aspect may include one or more of the following features. In one example, the actuating mechanism includes a roller coupled with a rotary actuator disposed inside the frame. In some cases, potions of the sheet are rolled around the roller, and the rotary actuator drives rotational movements of the roller to roll or unroll the sheet, thereby moving the sheet alongside the first window pane.

Furthermore, in some implementations, the glass of the window may include at least two spaced apart glasses. The sheet may be movably placed between the two glasses and the actuating mechanism may move the sheet between the two glasses. According to another implementation, the actuating mechanism may include a roller coupled with a rotary actuator disposed inside the frame. The sheet may be rolled around the roller and the rotary actuator may drive rotational movements of the roller to roll or unroll the sheet, thereby moving the sheet in front of the window.

Other systems, methods, features and advantages of the implementations will be, or will become, apparent to one of ordinary skill in the art upon examination of the following figures and detailed description. It is intended that all such additional systems, methods, features and advantages be included within this description and this summary, be within the scope of the implementations, and be protected by the following claims.

### BRIEF DESCRIPTION OF THE DRAWINGS

The drawing figures depict one or more implementations in accord with the present teachings. by way of example only. not by way of limitation. In the figures, like reference numerals refer to the same or similar elements.

FIG. 1 illustrates an implementation of a method for changing the amount of light that passes through a window;

FIG. 2A illustrates a perspective view of an implementation of a sheet associated with a window and FIG. 2B illustrates a top view of an implementation of the sheet associated with a window:

FIG. 3 illustrates a perspective view of an, implementation, of a sheet associated with a window:

FIG. 4 illustrates a perspective view of an implementation of a sheet associated with a window;

FIG. 5 illustrates a schematic representation of an implementation of a light adjustment apparatus associated with a window frame; and

FIG. 6 is a schematic representation of a functional block diagram of one implementation of a light adjustment system.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

Systems and methods directed to controlling and adjusting the amount of light that passes through a window pane by moving a sheet in front of a glass portion of the window are disclosed. Generally, the sheet may have a surface with different portions, where each portion of the surface has a specific transparency. An amount of transparency may be expressed as a degree or extent of darkness. The amount of light passing through the window may be changed by moving the sheet in front of or along the glass portion of the window. thereby positioning different portions of the sheet with different transparencies in front of the glass portion of the window. For example, as a first portion with a specific first transparency is moved into a position in front of the glass portion of the window, the light travels through the window with a first intensity corresponding to the first transparency. Moving the sheet such that a second portion of the sheet with a specific second transparency is moved into a position in front of the glass portion of the window causes the light to travel through the window with a second intensity. Further details and examples are presented below.

In some implementations, the sheet can include a gray anti-UV Thin Sheet Plexiglass that consists of different degrees of darkness, though in other implementations the sheet can include other materials capable of being rolled or wound and tinted. The degree of darkness differs from the top to the bottom and it changes from the lowest extent of darkness to the highest. The height of this sheet is several times as high as the height of window and it is coiled around two rollers, which are embodied as cylinders, from above and below. One of the cylinders is placed in the upper frame of the window and the other one is in the bottom frame. In one implementation, two electric gearbox motors open and close this sheet. These motors can be connected to an intelligent control system, which receives the light mode by a sensor inside the building and another sensor outside the building. In some implementations, after analyzing the received information, a control system commands the sheet to move either upward or downward. This causes the darkness of the sheet to change in the window frame, such that less or more light enter the building. In one implementation, this process occurs when the user puts the system in an automatic mode. for example, through a mobile phone and/or Wifi. In other cases, the user can control the extent of light manually.

In the manual control mode, when the darkness increasing key is pressed, the gearbox motors are activated, pulling the dark, sheet downward in order to display the darker part of the sheet against the window. Similarly, when the darkness decreasing key is pressed, the gearbox motors are activated and pull the dark sheet upward in order to display the ‘brighter’ part of the sheet. When the user finds the desired level of darkness of the window, he/she can stop this process.

In different implementations, the energy required for this system can be provided by solar cells. When the system is inactive, the energy received from the solar cells is saved in a battery in order to be used when needed. Furthermore, in some implementations, this system can be configured to measure the extent of light outside and inside the building by two light-measuring sensors which are installed inside and outside the window frame. The light measured is compared with a standard for the selected environment. In cases where the extent of light is lower than the standard (for example, the eyes will be damaged by working there), the system shows or emits a warning.

In some other implementations, the system can measure the intensity of light and display or show the light intensity to the user. Each environment can be associated with a need for a specific extent of light depending on its use (for example, a designing room needs more right than a sleeping room) so that the user working in that environment does not suffer from eye problems because of the lack of light. This system measures the intensity of the light depending on the standards that are defined for each environment and announces it to the user. In cases where the intensity of light is lower than the standard or normal level, the user is warned to prevent the eye problems which can be caused by working in a dark environment.

In some implementations, the method of using the system can include receiving information about lumen existing inside and outside the environment by the light sensor(s) and commanding the motors (which are coupled to the cylinders) to operate according to predetermined or preprogrammed instructions in the control system.

In another implementation, the system can include a panel or array of lights that are installed on a portion of the window frame. These lights can indicate the condition of the system to a user. For example, a green light indicates the normal mode, a yellow light is associated with a low-level warning, as well as a graphical warning on a smart phone, an orange light which is associated with a higher level warning as well as a graphical and audio warning on a smart phone. A red light could be associated with the highest warning (e.g., too dark), as well as a graphical and audio warning on a smart phone and switching on of a light.

In different implementations, the surface of a sheet may have a number of portions arranged throughout the sheet. Each portion may be associated with a different transparency relative to other portions, and/or two or more portions may be associated with a substantially similar transparency. The transparency of various portions can range from a zero transparency (i.e., no light passes through) to a full or a hundred percent transparency (i.e. all light passes through). In some implementations, the transparencies across the portions may change discretely from one portion to the next. In another implementation, the transparencies across the portions may change continuously or progressively from one portion to the next, as a gradient. Benefits from this type of system include, but are not limited to providing a user with a means of controlling and adjusting the amount of light that travels through a window via a simplified and relatively inexpensive system and method.

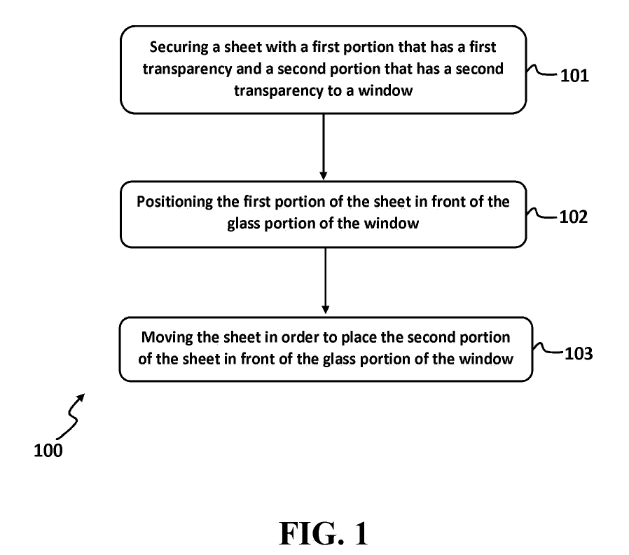

Referring now to FIG. 1, a method 100 for changing the amount (intensity) of light that passes through a window pane according to one implementation of the present disclosure is illustrated. The method 100 includes a first step 101 of providing or securing a sheet that has a surface with a first portion that has a first transparency and a second portion that has a second transparency to a window. A second step 102 includes placing or positioning the first portion of the sheet in front of at least a portion of the glass portion of the window in order to allow the light to pass through the window with a first intensity. In a third step 103, the method involves moving or repositioning the sheet in order to place or position the second portion of the sheet in front of at least a portion of the glass portion of the window in order to change the light intensity passing through the window, from the first intensity to a second intensity.

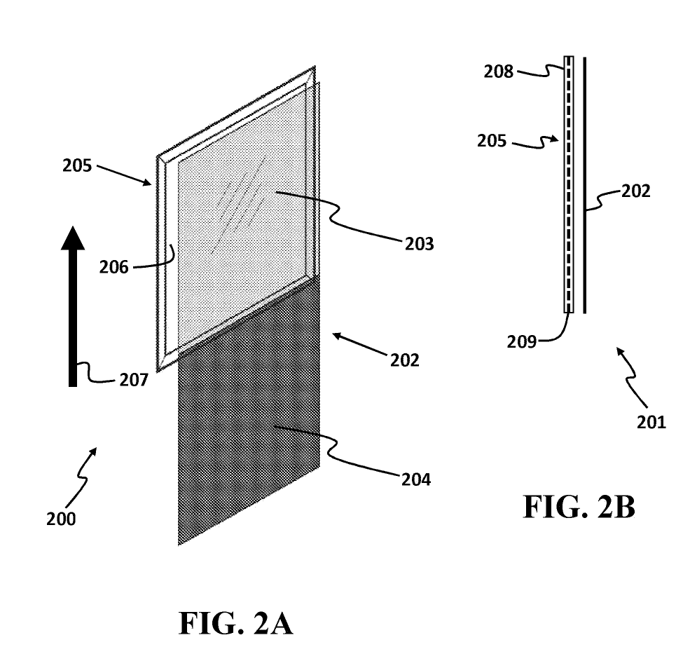

In different implementations, the sheet utilized in the method and systems herein can include various shapes, sizes, and materials. As an example, FIG. 2A illustrates a perspective view 200 of a first sheet (“sheet”) 202 and FIG. 2B illustrates a top view 201 of the same sheet 202. In the implementation depicted in FIGS. 2A it can be seen that the sheet 202 has a plurality of portions. For example, a first portion 203 and a second portion 204 are identified in FIG. 2A. The first portion 203 and the second portion 204 are arranged directly adjacent to one another in a lengthwise direction (i.e., in a direction extending from the top of the window toward the bottom of the window). In other implementations. the sheet 202 can include differently sized or shaped portions and/or additional portions arranged in various configurations, depending on the requirements of the window system and user. For example, in some implementations, the sheet can include a third portion disposed between the first portion and the second portion in the lengthwise direction, or a third portion can extend from the second portion and join to a fourth portion, or other additional portions with varying transparency. In FIG. 2A, the sheet 202 is positioned such that the first portion 203 is disposed directly alongside or against a window 205. In one implementation, at least some portions of the sheet 202 may include a transparent material, such as a thin Plexiglas material or sheet.

In addition, in some implementations, the first portion 203 of the sheet 202 may have a first transparency between zero percent (i.e. no light passes through) and a hundred percent (i e., all light passes through). Similarly, the second portion 204 of the sheet 202 may have a second transparency between zero percent (i.e. no light passes through) and a hundred percent (i e., all light passes through). In one implementation, the first portion 203 and/or the second portion 204 may be tinted by. for example, a specific amount of ink to create the desired level or degree of transparency thereon. In other implementations, the various portions of a sheet can be manufactured and tinted by exposure to a heat treatment process using specially formulated chemical dyes, a ‘Constant Density’ process, metalized tinting, color fusion, or other tinting processes known in the art,

Referring again to FIG. 2A, it can be seen that in this example the sheet 202 is positioned alongside the window 205 such that the first portion 203 with the first transparency is disposed directly in front of a glass portion 206 of the window 205. Light with an initial intensity can travel through the window 205, passing through the glass portion 206 and the first portion 203, and entering the room with a first intensity. The first intensity can be understood to be a function of the first transparency of the first portion 203. As noted earlier, the system is configured to permit adjustments to the intensity of the light that travels through the window 205 and enters the room. For example, the sheet 202 may be moved alongside of the window 205 in a direction shown by arrow 207 in order to position the second portion 204 in front of the glass portion 206 of the window 205. In one implementation, the sheet 202 moves in a substantially parallel direction relative to the window pane. As the portion positioned alongside the window pane is replaced by another (second) portion, the intensity of the light that passes through the window 205 and enters the room changes from the first intensity to a second intensity, where the second intensity is a function of the second transparency.

With further reference to FIG. 2B, according to an implementation, the sheet 202 may be directly placed in front of the window 205 or alternatively, in another implementation, the sheet 202 may be placed in a frame 208 of the window, such that the sheet (illustrated as a dashed line 209) is movable inside the frame 208, as will be described in detail further below. The sheet 202 may be sized and shaped such that a portion of the sheet 202 covers a majority or substantial entirety of the glass surface area of the window 205.

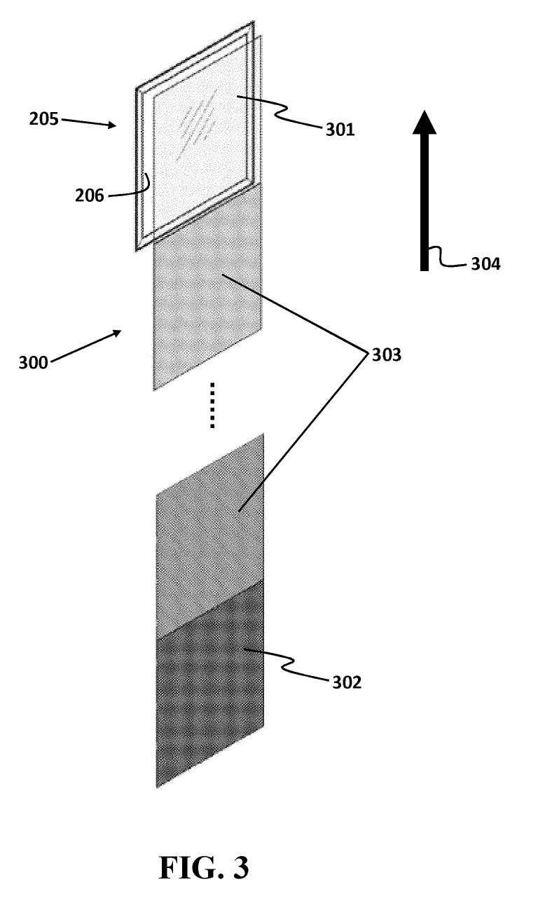

Another example of the system is presented in the isometric view of FIG. 3. In FIG. 3 a second sheet 300 is associated with window 205. The second sheet 300 includes a first portion 301 with a first transparency, a second portion 302 with a second transparency, and a number of intermediate portions 303 with, various respective transparencies. In some implementations, the first portion 301 of the second sheet 300 may have a first transparency between zero percent (i.e. no light passes through) and a hundred percent (i.e., all light passes through). The second portion 302 of the second sheet 300 may have a second transparency between zero percent (i.e. no light passes through) and a hundred percent (i.e., all light passes through). Furthermore, the intermediate portions 303 may have respective transparencies ranging between the first transparency and the second transparency. For example, transparencies of each of the intermediate portions 303 may begin from or near the first transparency level and change in discrete steps from one intermediate portion to the next, until the second transparency level is reached.

In FIG. 3, the second sheet 300 is arranged alongside the window 205 such that the first portion 301 is positioned in front of or against the glass portion 206 of the window 205. Light with an initial intensity travels through the window 205, passing through, the glass portion 206 and the first portion 301. thereby entering the room with a first intensity, which is a function of the first transparency of the first portion 203. In order to change the intensity of the light that enters the room, the second sheet 300 may be moved in front of the window 205 in a direction shown by arrow 304 in order to place another portion (for example, one of the intermediate portions 303 or the second portion 302) alongside the glass portion 206 of the window 205. This transition changes the intensity of the light that enters the room, from the first intensity to an intensity corresponding to the transparency of the portion that is placed in front of the window 205.

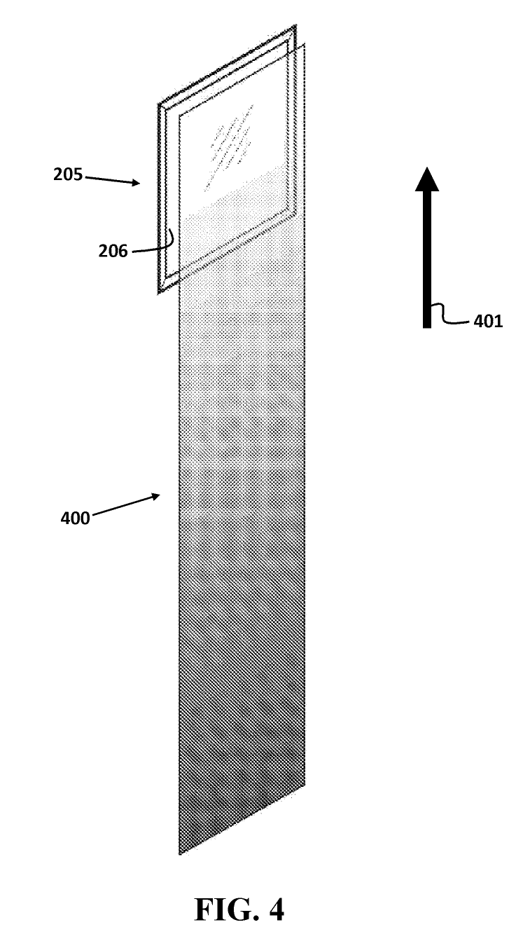

Another example, is presented in FIG. 4, In FIG. 4 an isometric view of a third sheet 400 associated with the window 205 is shown. The third sheet 400 is a substantially transparent sheet that is colored with a gradient tint, according to one implementation of the present disclosure. It can be understood that the transparency level of the third sheet 400 changes in a substantially, continuous or gradual manner along its length, ranging between a first transparency to a second transparency. The first transparency and the second transparency amounts may be values between zero percent (i.e. no light passes through) and a hundred percent (i.e., all light passes through).

Referring to FIG. 4, the third sheet 400 is in a first position alongside the window 205. In order to change the intensity of the light that travels through the window 205 and enters the room, the third sheet 400 may be moved in front of or alongside the window 205 in a direction shown by arrow 401 in order to transition to a second position. The second position can refer to the configuration in which a different portion of the sheet 400 with a desired different transparency is positioned in front of the glass portion 206 of the window 205, thereby changing the intensity of the light that passes through the window 205 and enters the room.

In different implementations, the sheet system can include provisions for securing, installing, attaching, mounting, or otherwise associating the sheet with a window. As noted above, in some implementations, the sheet—with portions either discretely or continuously tinted—may be placed inside a frame of a window. For example, in a double-glazed window, the sheet may be movably disposed between the two glass panes of the window. In other implementations, the sheet may be mounted, for example on a surface near the window, in front of the glass portion of the window. In one implementation, the length of the sheet is several times greater than the height of the glass portion of the window, thereby allowing for having multiple portions on the sheet with a similar surface area as the glass portion of the window, each being configured to be positioned in front of the window. In some implementations, the sheet may be configured to slide in a direction substantially parallel to that of the window pane. In another implementation, the sheet may be pulled or drawn in a manner similar to that of a curtain or shade. Thus, in some cases, at least some portions of the sheet can be in a rolled configuration or compressed configuration while another portion extends in a substantially flat or planar configuration alongside the window pane. For example, a portion of the sheet can be disposed adjacent to and extend across the window pane in a substantially parallel manner. In other implementations, a horizontal movement of the sheet in front of the window may be understood to be in the scope of the present disclosure.

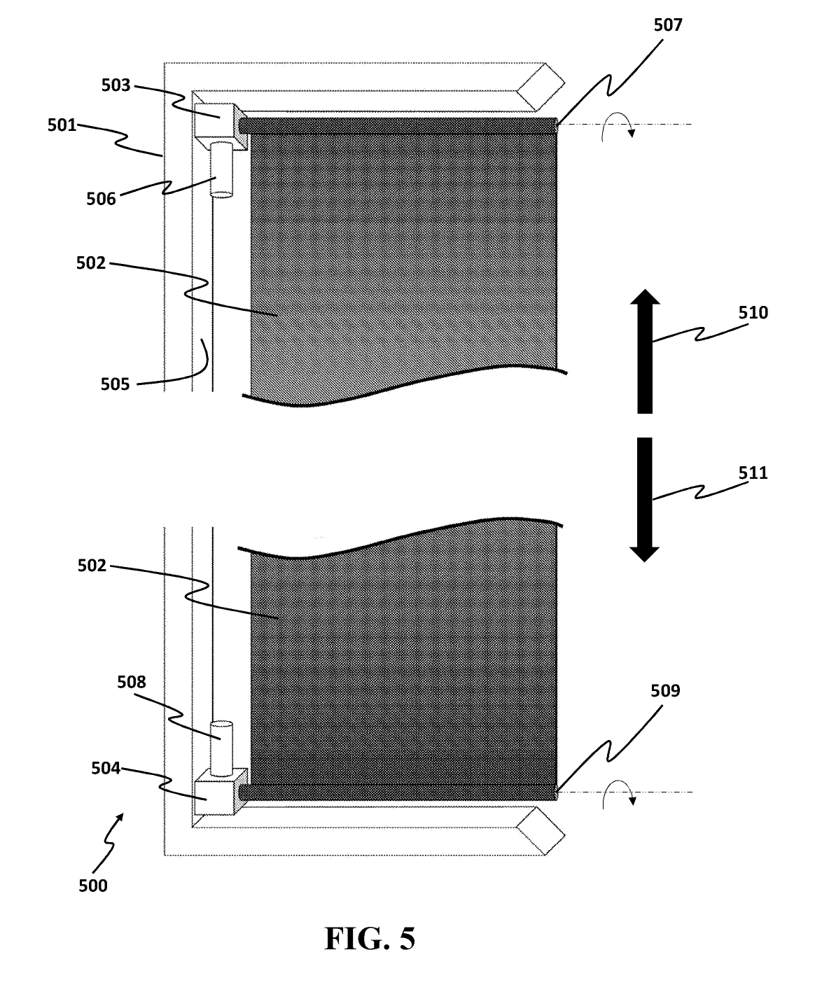

For purposes of illustration, FIG. 5 depicts one example of an apparatus incorporating a sheet as described herein. In FIG. 5 a schematic representation of an implementation of a light adjustment apparatus (“apparatus”) 500 is shown, the apparatus 500 being associated with a window frame 501. The apparatus 500 can include a transparent tinted sheet 502, a first actuating mechanism 503, and a second actuating mechanism 504. The first actuating mechanism 503 and the second actuating mechanism 504 may each be attached or secured to the window frame 501. For example, in one implementation, the first actuating mechanism 503 and the second actuating mechanism 504 may be attached or secured to an inner surface 505 (for example, the surface facing an interior environment) of the window frame 501. The first actuating mechanism 503 may include a rotary actuator, such as a first motor 506 that may be coupled with an actuator, such as a first roller 507. The sheet 502 may be rolled around the first roller 507 and the first motor 506 and the first roller 507 may be configured for rolling and unrolling (or winding and unwinding) the sheet 502. The second actuating mechanism 503 may include a rotary actuator, such as a second motor 508 that may be coupled with an actuator such as a second roller 509. The sheet 502 may be rolled around the second roller 509 and the second motor 508 and the second roller 509 may be configured for rolling and unrolling (or winding and unwinding) the sheet 502, In one implementation, the first roller and the second roller are disposed along opposite ends of the window, allowing the portion with the desired transparency to extend between the first roller and the second roller and cover or run alongside the length of the window pane.

Furthermore, in some implementations, the first motor 506 is coupled with the first roller 507 in order to cause a rotational movement of the first roller 507 in a clockwise or counterclockwise manner to either roll or unroll sheet 502, Similarly, the second motor 508 can be coupled with the second roller 509 in order to cause a rotational movement of the second roller 509 in a clockwise or counterclockwise manner to either roll or unroll sheet 502.

Referring to FIG. 5, in some implementations, substantially synchronized rotations of the first roller 507 and the second roller 509 in similar directions (clockwise or counterclockwise) may cause the sheet 502 to move or translate in one of two generally opposing directions, shown by arrows 510 and 511. For example, a synchronized clockwise rotation of the first roller 507 and the second roller 508 can cause the first roller 507 to roll sheet 502 around first roller 507 while the second roller 509 unrolls sheet 502 from around the second roller 509, thereby causing the sheet 502 to move downward along the direction shown by arrow 511. Similarly, a synchronized counterclockwise rotation of the first roller 507 and the second roller 508 can cause the second roller 509 to roll sheet 502 around second roller 509 while the first roller 507 unrolls sheet 502 from around the first roller 507, thereby causing the sheet 502 to move upward along the direction shown by arrow 510. It should be understood that in other implementations, the mechanism of the system may be reversed, such that the clockwise rotation is configured to move the sheet upward and the counterclockwise rotation causes the sheet to move downward.

In other implementations, the second roller 509 of the light adjustment apparatus 500 may alternatively be coupled with the first motor 506 of first actuating system 503 by a power transmission system, such as a gearbox, belt-and-pulley, or gear-and-chain (not shown in FIG. 5). In such a case, as the first motor 506 rotates, both first roller 507 and second roller 509 rotate in a synchronized manner. Benefits from the coupling of the second roller 509 with the first motor 506 include the elimination of the second motor 508 from the light adjustment apparatus 500, which can simply the system and allow for more cost-effective manufacturing.

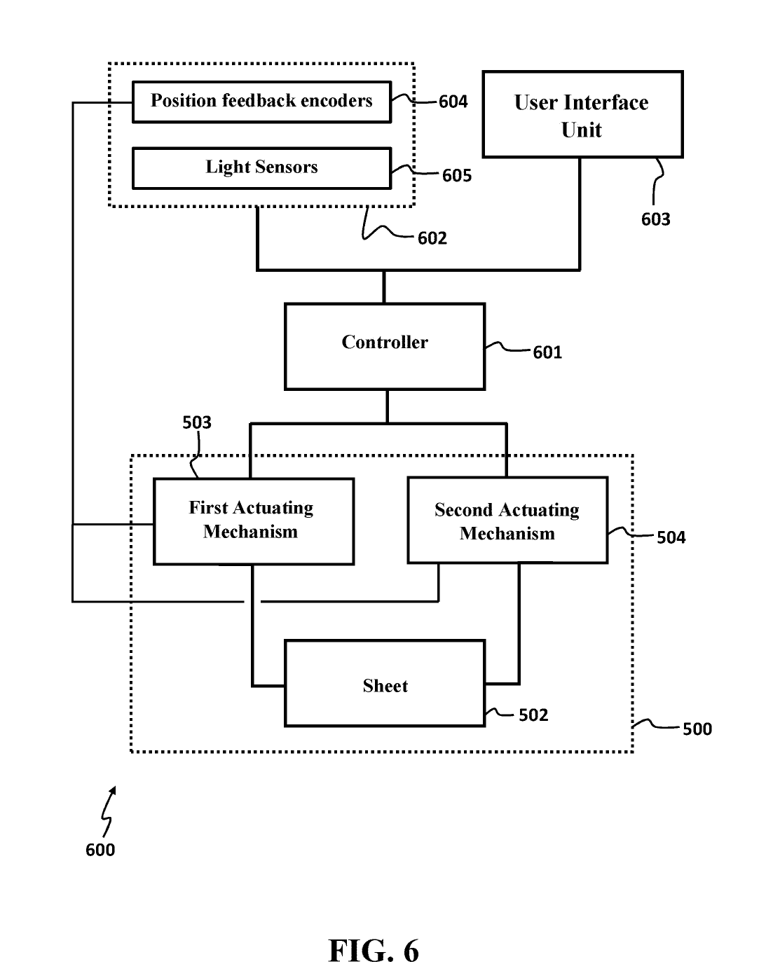

Referring now to FIG. 6, a schematic representation of a functional block diagram of one implementation of a light adjustment system (“system”) 600 is depicted. The light adjustment system 600 may include the light adjustment apparatus 500, a controller 601, a sensor system 602, and a user interface unit 603. The light adjustment apparatus 500, as was described in detail in connection with FIG. 5, may include first actuating mechanism 503 and second actuating mechanism 504 that are coupled with the sheet 502.

In some implementations, the controller 601 may be coupled to the light adjustment apparatus 500, the sensor system 602, and the user interface unit 603 through, for example, wired links (not explicitly visible in FIG. 6), wireless links (not explicitly visible in FM. 6), or a combination of wired and wireless links.

Furthermore, in one implementation, the controller 601 may be configured to control motions of the first actuating mechanisms 503 and, second actuating mechanism 504 thereby controlling the positioning of different portions of the sheet 502 in front of or alongside a window pane. The controller 601 can be operatively coupled to the sensor system 602 and to the user interface unit 603, for purposes that may include calculating the position and the motion of the first actuating mechanisms 503 and second actuating mechanism 504. The calculation of the position and the motion of the first actuating mechanisms 503 and second actuating mechanism 504 may be based, at least in part, on data received from a user through the user interface unit 603, or data received from the sensor system 602, or both.

In different implementations, the sensor system 602 may include position feedback encoders 604 and light sensors 605. The position feedback encoders 604 may be coupled to motors (such as the first motor 506 and second motor 508 of FIG. 5) that move the sheet 502. The position feedback encoders 604 may include, for example, conventional commercially available absolute or incremental encoders, or both, and may comprise conventional commercially available linear or rotary encoders, or both. The light sensors 605 may be utilized in the measurement of the intensity of light in both the inside and outside environments. In one implementation, the light sensors 605 are configured to transmit the corresponding information to the controller 601.

The user interface unit 603 may provide means for receiving data input from a user. One example implementation of the user interface unit 603 may include, for example, a graphical user interface (GUI) unit. In other implementations, the user interface unit 603 is a panel with control or input buttons. The user interface unit 603, in combination with the controller 601, can provide means for a user to interactively control the amount of light that passes through the window through corresponding control of the movements of the sheet 502 in front of the window. Data input by the user can include. for example, a desirable light intensity for the room, a daily or weekly schedule or timer for changes to the light intensity, directives for multiple sheets (corresponding to additional windows) or other such settings. The desirable light intensities may be presented to the user through the user interface unit 603 as preset intensities or can be inputted manually by the user.

The controller 601 may be configured with a memory (not explicitly visible in FIG. 6) for including executable instructions that, when executed, cause the controller 601 to perform operations to further processes and methods disclosed herein. Such operations can include, for example, conversion of the light intensity and the movement data received from the sensor system 602, and from the user interface unit 603, to appropriate units along the rotational axes in which the first actuating mechanism 503 and second actuating mechanism 504 can move in order to move the sheet 502 in front of the window.

This type of system can allow a user to adjust the light intensity of a room by adjusting the amount of natural light that passes through the winclow(s) of that room. The user may choose between preset intensities corresponding to, for example, light intensities suitable for reading, sleeping, using a computer, cooking, or watching TV. Moreover, the light intensity of the room may be adjusted automatically using a controller based on the measured light intensities of inside and/or outside the room, or based on the temperature of the room. Furthermore, all these functions are possible by the utilization of a simple and inexpensive tinted transparent sheet as described with respect to the systems and methods disclosed herein.

Other advantages the system described herein can provide include minimizing the loss of energy typically required to provide light, coolness or heat for a building; ease of installation, particularly in two-layered glasses, partitions, and glass doors; the ability to filter harmful rays like ultra-violet up to 99% by using gray anti-UV sheets and preventing UV penetration through the window, decreasing eye problems as well as the color fade or erosion of home furniture; the ability to limit the view when desired; a relatively low cost of production, maintenance, and extra or replacement parts.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step. feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations. This is for purposes of streamlining the disclosure, and is not to be interpreted as reflecting an intention that the claimed implementations require more features than are expressly recited in each claim. Rather, as the following claims reflect, inventive subject matter lies in less than all features of a single disclosed implementation. Thus, the following claims are hereby incorporated into the Detailed Description, with each claim standing on its own as a separately claimed subject matter.

While various implementations have been described. the description is intended to be exemplary, rather than limiting and it will be apparent to those of ordinary skill in the art that many more implementations and implementations are possible that are within the scope of the implementations. Although many possible combinations of features are shown in the accompanying figures and discussed in this detailed description, many other combinations of the disclosed features are possible. Any feature of any implementation may be used in combination with or substituted for any other feature or element in any other implementation unless specifically restricted. Therefore, it will be understood that any of the features shown and/or discussed in the present disclosure may be implemented together in any suitable combination. Accordingly, the implementations are not to be restricted except in light of the attached claims and their equivalents. Also, various modifications and changes may be made within the scope of the attached claims.

What is claimed is:

1. A method for adjusting light intensity of light passing through a window pane of a window, the method comprising:
securing a sheet to the window, the sheet including plurality of portions, the plurality of portions including at least a first portion with a first transparency and a second portion with a second transparency, the first transparency differing from the second transparency;
positioning the sheet in a first position alongside the window pane such that the first portion extends directly alongside the window pane; and
transitioning the sheet from the first position to a second position such that the second portion of the sheet extends alongside the window pane.

2. The method of claim 1, wherein:
at least a third portion with a third transparency is disposed between the first portion and the second portion in a lengthwise direction, and
the first transparency is greater than the second transparency, and wherein the third transparency is less than the first transparency and greater than the second transparency.

3. The method of claim 2, wherein the transparencies of each of the first portion, second portion, and third portion change discretely from one portion to the next.

4. The method of claim 2, wherein the third portion includes a gradient tint, such that the transparency of the third portion varies gradually across a length of the third portion.

5. The method of claim 1, wherein:
the window pane has a surface area, and
each portion of the sheet is sized to cover at least the surface area of the window pane.

6. The method of claim 1, wherein securing the sheet to the window includes mounting the sheet to a surface adjacent to the window.

7. The method of claim 1, wherein securing the sheet to the window includes securing a first motor and a first roller to a surface adⱼacent to the window.

8. The method of claim 7, wherein transitioning the sheet from the first position to the second position includes winding the first portion of the sheet onto the first roller by activation of the first motor.

9. The method of claim 1, further comprising selecting a desired light intensity on a controller associated with the sheet.

10. The method of claim 1, wherein transitioning the sheet from the first position to the second position includes unwinding the second portion from a second roller.

11. A system for adjusting light intensity passing through a window pane of a window, the system comprising:
a sheet with a plurality of portions, the plurality of portions including at least a first portion with a first transparency and a second portion with a second transparency that differs from the first transparency; and
an actuating mechanism coupled to the sheet, the actuating mechanism being configured to move the sheet between a first position in which the first portion extends alongside the window pane to a second position in which the second portion extends alongside the window pane.

12. The system of claim 11, wherein:
the actuating mechanism includes a roller coupled with a rotary actuator, and
the rotary actuator drives rotational movements of the roller to roll or unroll the sheet around the roller, thereby moving different portions of the sheet in front of the window.

13. The system of claim 11, further comprising a controller configured to transmit commands to the actuating mechanism, thereby adjusting a relative position of each, of the portions of the sheet.

14. The system of claim 13, further comprising a sensor system configured to measure the light intensity of light that passes through the window pane, and wherein the sensor system is coupled to the controller.

15. The system of claim 11, further comprising a user interface unit configured to receive input from a user regarding a selection of a predefined amount of light intensity permitted to pass through the window.

16. The system of claim 11, wherein:
the plurality of portions further includes a third portion disposed between the first portion and the second portion, wherein the third portion has a third transparency, and
the third transparency is between the first transparency and the second transparency.

17. The system of claim 16, wherein the third transparency is substantially constant along the third portion.

18. The system of claim 16, wherein the third portion includes a gradient tint, whereby the third transparency varies gradually along a length of the third portion.

19. A window system capable of adjusting light intensity of light passing through a window, the window system comprising:
a frame surrounding a first window pane, the first window pane including glass;
a sheet extending between a first roller and a second roller, the sheet including a plurality of portions, wherein each portion has a respective transparency; and
an actuating mechanism coupled to the sheet configured to position different portions of the sheet alongside the first window pane.

20. The window according to claim 11, wherein:
the actuating mechanism includes a roller coupled with a rotary actuator disposed inside the frame,
potions of the sheet are rolled around the roller, and
the rotary actuator drives rotational movements of the roller to roll or unroll the sheet, thereby moving the sheet alongside the first window pane.
